(19) United States
(12) Patent Application Publication
(10) Pub. No.: US 2009/0040128 A1
(43) Pub. Date: Feb. 12, 2009

(54) MOBILE APPARATUS AND METHOD OF MANUFACTURING THE SAME

(75) Inventors: Jae Suk SUNG, Yongin (KR); Gi Tae Do, Suwon (KR); Ju Hyung Kim, Seoul (KR); Ha Ryong Hong, Hwasung (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/187,062

(22) Filed: Aug. 6, 2008

(30) Foreign Application Priority Data
Aug. 8, 2007 (KR) 10-2007-79614

(51) Int. Cl. H01Q 1/40

(52) U.S. Cl. 343/873

(57) ABSTRACT

There is provided a mobile apparatus including: a thin film provided as a substrate; at least one conductive pattern formed on at least one surface of the thin film; a circuit part formed on the at least one surface of the thin film to connect to the connect to the conductive pattern; and a housing formed integral with the thin film. Also, there is provided a method of manufacturing the same.

### CROSS-REFERENCE TO RELATED APPLICATIONS

This application claims the priority of Korean Patent Application No. 2007-79614 filed on Aug. 8, 2007, in the Korean Intellectual Property Office, the disclosure of which is incorporated herein by reference.

### BACKGROUND OF THE INVENTION

1. Field of the Invention

The present invention relates to a mobile apparatus and a method of manufacturing the same, and more particularly, to a mobile apparatus utilizing a thin film substrate where a conductor pattern is formed and electronic devices are mounted, and a method of manufacturing the same.

2. Description of the Related Art

Recently, with widespread use of a mobile telecommunication terminal such as a global positioning system (GPS), a personal digital assistant (PDA), a cellular phone, and a wireless laptop computer, there has been a rising demand for reducing size and weight thereof. To meet this demand, a research mainly aimed at achieving a less bulky mobile apparatus with various functions has been under way. Particularly, consumers increasingly require the mobile telecommunication terminal to be smaller-sized.

In a conventional mobile apparatus, active and passive devices are mounted on a printed circuit board (PCB) using surface mount technology (SMT). To form this printed circuit board, typically, a plurality of slurries made of e.g., FR4 or epoxy are deposited and sintered to a thickness of at least 0.8 mm. This thickness has been a hindrance to a smaller size of the mobile apparatus. Besides, the printed circuit board has predetermined hardness due to the sintering. This has restricted freedom in designing the external appearance of the mobile apparatus having the printed circuit board embedded therein.

### SUMMARY OF THE INVENTION

An aspect of the present invention provides a mobile apparatus employing a thin film substrate to be reduced in volume and increased in freedom in designing the external appearance thereof, and a method of manufacturing the same.

According to an aspect of the present invention, there is provided a mobile apparatus including: a thin film provided as a substrate; at least one conductive pattern formed on at least one surface of the thin film; a circuit part formed on the at least one surface of the thin film to connect to the conductive pattern; and a housing formed integral with the thin film.

The thin film may be a flexible film.

The thin film may be a polymer-based film.

The at least one conductive pattern may be an antenna pattern. The antenna pattern may include two antenna patterns formed on both surfaces of the thin film, respectively. The antenna patterns may have an identical shape and size to each other to form a balanced antenna, the antenna patterns being symmetrical with respect to each other.

The housing may be formed integral with the thin film by in-molding.

The mobile apparatus may be a mobile communication terminal.

According to another aspect of the present invention, there is provided a method of manufacturing a mobile apparatus, the method including: forming at least one conductive pattern and at least one electrode connected to the conductive pattern to form a circuit on at least one surface of a thin film; mounting at least one electronic device on the thin film to connect to the at least one electrode to form a circuit part; inserting the thin film into a mold of a housing shape; and injecting a molding material into the mold to form a housing to be integral with the thin film.

The thin film may be a flexible film.

The thin film may be a polymer-based film.

The forming at least one conductive pattern and at least one electrode may include printing a conductive ink.

The forming at least one conductive pattern and at least one electrode may include performing sputtering.

The forming at least one conductive pattern and at least one electrode may include bonding a metal foil.

The forming at least one conductive pattern and at least one electrode may include performing lithography.

The at least one conductive pattern may be an antenna pattern.

The antenna pattern may include two antenna patterns formed on both surfaces of the thin film, respectively.

The antenna patterns may have an identical shape and size to each other to form a balanced antenna, the antenna patterns being symmetrical with respect to each other.

The mobile apparatus may be a mobile communication terminal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a cross-sectional view and FIG. 1B is a plan view illustrating a mobile apparatus, respectively according to an exemplary embodiment of the invention;

FIG. 2A is a cross-sectional view and FIG. 2B is a partial exploded view illustrating a mobile apparatus according to another exemplary embodiment of the invention; and

FIG. 3A to 3D sequentially illustrate a method of manufacturing a mobile apparatus according to an exemplary embodiment of the invention.

### DETAILED DESCRIPTION OF THE PREFERRED EMBODIMENT

Exemplary embodiments of the present invention will now be described in detail with reference to the accompanying drawings.

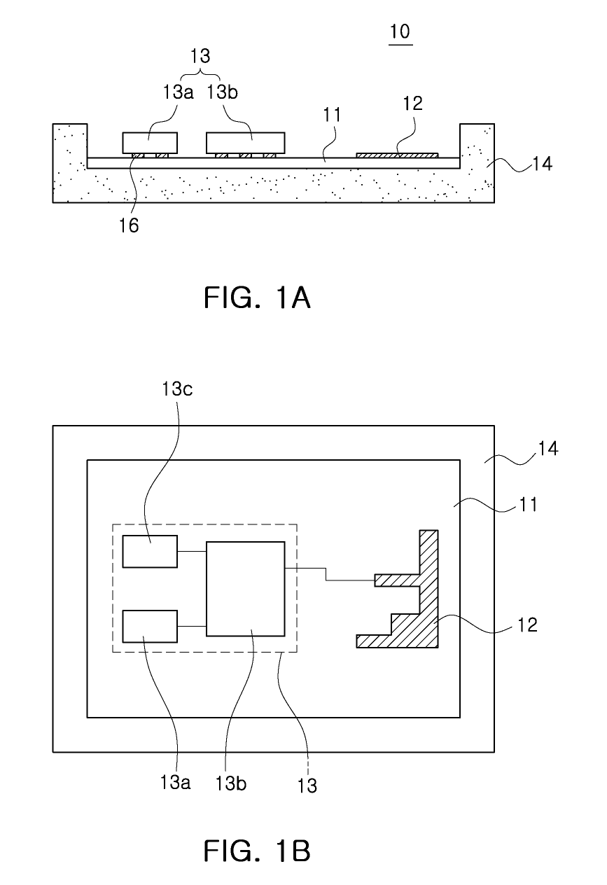

FIG. 1A is a cross-sectional view and FIG. 1B is a plan view illustrating a mobile apparatus, respectively according to an exemplary embodiment of the invention.

Referring to FIGS. 1A and 1B, the mobile apparatus 10 of the present embodiment includes a thin film 11, a conductive pattern 12 formed on the thin film, a circuit part 13 mounted on the thin film, and a housing 14.

In the present embodiment, the thin film 11 can serve as a substrate. That is, the conductive pattern 12 and electrodes 16 for mounting devices thereon can be formed on the thin film 11. The thin film 11 may be polymer-based. The polymer-based thin film is flexible so as to be positioned with greater freedom than in a case where a conventional printed circuit board (PCB) is employed.

Moreover, the polymer-based film may be formed to a thickness of 0.1 mm, thereby capable of being mounted with an overall smaller space than in a case where the PCB is employed.

More than one conductive pattern 12 may be formed on the thin film 11.

The conductive pattern 12 may be an antenna pattern. In the present embodiment, the antenna pattern is formed on only one surface of the thin film 11. Alternatively, two antenna patterns may be formed on both surfaces of the thin film 11, respectively. Moreover, to achieve multi-band antenna characteristics, a plurality of antenna patterns with different shapes from one another may be formed.

Electronic devices 13a, 13b and 13c may be mounted on the thin film 11 to constitute the circuit part 13. To allow the electronic devices to be mounted, the plurality of conductive electrodes 16 are formed on the thin film 11. To ensure electrical connection of the circuit part 13 mounted on the thin film 11, a circuit pattern may be formed on the thin film to connect the conductive electrodes 16 together.

As in the present embodiment, the antenna pattern is directly formed on the thin film 11 to have active and passive devices mounted thereon. This reduces volume of a mobile apparatus over the conventional technology using the PCB.

The thin film 11 may be formed integral with the housing 14.

In the present embodiment, the housing 14 may be a case of a mobile telecommunication terminal. The thin film 11 may be bonded onto one surface of the housing 14. In the present embodiment, the conductive pattern 12 and the electrodes 16 are formed on one of surfaces of the thin film 11 and the housing 14 is formed in contact with another surface of the thin film 11 where the conductive pattern is not formed. However, the conductive pattern may be formed on the another surface where the thin film 11 is brought in contact with the housing 14.

The housing 14 may be formed by in-molding. That is, the thin film 11 having the conductive pattern formed thereon and the electronic devices mounted thereon is positioned inside a mold of a housing shape. Then, a liquid molding material is injected into the mold to form a housing. Therefore, even though the conductive pattern is formed on the surface of the thin film 11 in contact with the housing 14, the housing 14 and the thin film 11 remain bonded together.

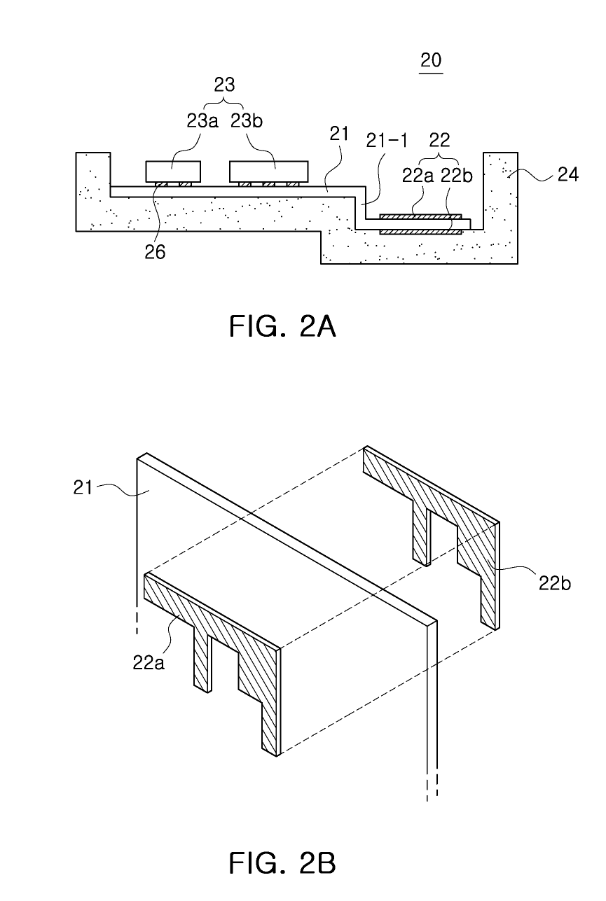

FIG. 2A is a cross-sectional view and FIG. 2B is a partial exploded view illustrating a mobile apparatus according to another exemplary embodiment of the invention.

Referring to FIG. 2A, the mobile apparatus 20 of the present embodiment includes a thin film 21, a conductive pattern 22 formed on the thin film, a circuit part 23 mounted on the thin film and a housing 24.

In the present embodiment, the thin film 21 may serve as a substrate. That is, a conductive pattern 22 and electrodes 26 for mounting electronic devices thereon may be formed on the thin film. The thin film 21 may be polymer-based. The polymer-based film is flexible so as to be positioned with greater freedom than in a case where the conventional PCB is utilized. In the present embodiment, the thin film 21 may have a bent portion 21-1 formed therein along a bending shape of the housing 24.

Also, the polymer-based film can be formed to a thickness of 0.1 mm, thus capable of being mounted with an overall smaller space than in a case where the PCB is employed.

More than one conductive pattern 22 may be formed on the thin film 21.

The conductive pattern 22 may be an antenna pattern. In the present embodiment, first and second antenna patterns 22a and 22b may be formed on both surfaces of the thin film 21, respectively. For example, the first and second antenna patterns 22a and 22b formed on the both surfaces of the thin film 21, respectively are designed to have an electrical resonant length different from each other to thereby achieve a dual band antenna in a limited area. Alternatively, the first and second antenna patterns 22a and 22b may be designed to have an identical shape and size to each other and arranged in symmetry with respect to each other. This assures a balanced antenna which is less susceptible to noise or external environment.

A circuit part 23 may be formed on the thin film 21 to have electronic devices 23a and 23b mounted thereon. To allow the electronic devices to be mounted, the plurality of conductive electrodes 26 are formed on the thin film 21. To ensure electrical connection of the circuit part 23 mounted on the thin film 21, a circuit pattern (not shown) for connecting the conductive electrodes 26 may be formed on the thin film.

As in the present embodiment, the antenna pattern is directly formed on the thin film 21 to have the electronic devices mounted thereon. This allows the mobile apparatus to be reduced in volume over the conventional technology utilizing the PCB.

The thin film 21 may be formed integral with the housing 24.

In the present embodiment, the housing 24 may be a case of a mobile telecommunication terminal. The thin film 21 may be bonded onto one surface of the housing 24.

The housing 24 may be formed by in-molding. That is, the thin film 21 having the conductive pattern formed thereon and the electronic devices mounted thereon is positioned inside a mold of a housing shape. Then, a liquid molding material is injected into the mold and cold-cured to form a housing.

FIG. 2B illustrates an arrangement antenna patterns 22a and 22b formed on the thin film 21.

In the present embodiment, to obtain a balanced antenna, the first and second antenna patterns 22a and 22b formed on both surfaces of the thin film 21, respectively may be formed in an identical shape to each other.

The first and second antenna patterns 22a and 22b may be arranged in symmetry with respect to each other to form the balanced antenna. That is, the first and second antenna patterns 22a and 22b may have an identical size and shape to each other and be arranged to oppose each other. Moreover, the first and second antenna patterns may have separate feeding terminals to be connected to different polarities, respectively. This as a result realizes the balanced antenna.

In this balanced antenna, the first and second antenna patterns 22a and 22b exhibit balanced current characteristics so that outputs therefrom are identical in size but 180 degrees out of phase. This ensures the antenna to be less susceptible to noise and external environment change.

In the present embodiment, also, to achieve multi-band antenna characteristics, in place of the two antenna patterns 22a and 22b, a plurality of antenna patterns with different shapes from one another may be formed.

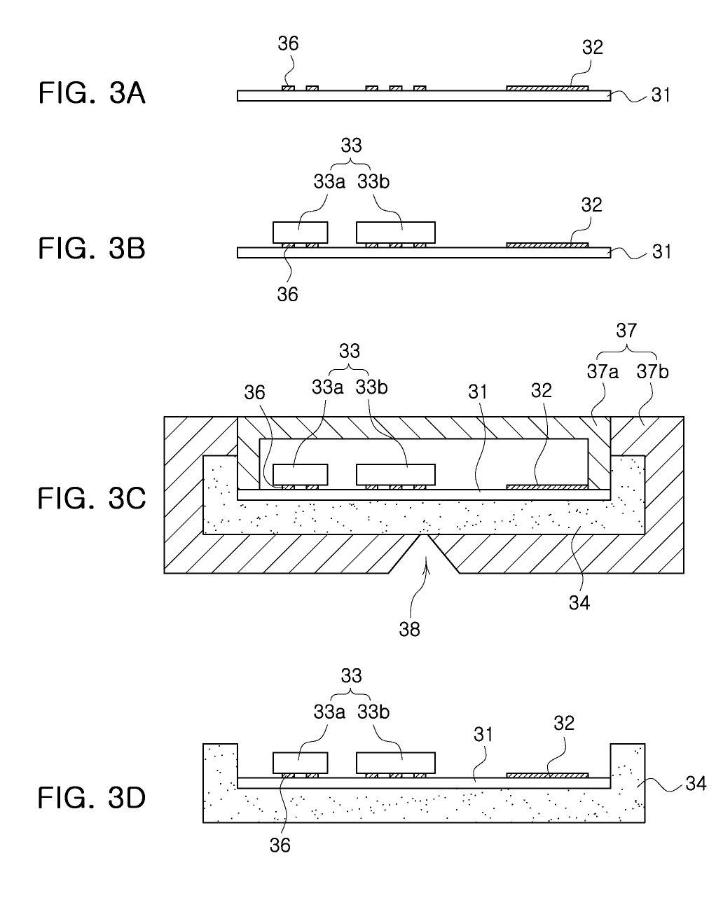

FIGS. 3A to 3D sequentially illustrate a method of manufacturing a mobile apparatus according to an exemplary embodiment of the invention.

In FIG. 3A, a conductive pattern 32 and electrodes 36 are formed on one surface of a thin film 31.

The conductive pattern 32 may be formed uniformly. The electrodes 36 may have electronic devices mounted thereon. The conductive pattern 32 and the electrodes 36 may be connected to each other to form a circuit.

The conductive pattern 32 and the electrodes 36 can be formed on the thin film 31 by various methods. That is, a conductive ink may be printed on the thin film 31. Sputtering or lithography may be performed or a metal foil may be bonded. Also, the conductive pattern 32 and the electrodes 36 can be formed simultaneously or separately.

In FIG. 3B, electronic devices are mounted on the electrodes formed on the thin film to form a circuit part.

The circuit part 33 mounted on the thin film 31 may be connected to a circuit pattern (not shown) formed on the thin film by the electrodes 36.

In FIG. 3C, the thin film is inserted into a mold of a housing shape and a molding material is injected into the mold to form a housing to be integral with the thin film.

In the present embodiment, the mold 37 of a housing shape includes an upper mold 37a and a lower mold 37b. The upper mold 37a supports the thin film 31 and the lower mold 37b serves as a frame of the housing to be formed integral with the thin film.

After the thin film 31 is disposed between the upper mold 37a and the lower mold 37b, a liquid molding material is injected into the mold through an injection hole 38 formed in the lower mold 37b.

Thereafter, the molding material injected is cold-cured to form the housing 34 of a desired shape, and then the mold is removed.

With the mold removed, as in FIG. 3D, the thin film 31 having the conductive pattern 32 formed thereon and the circuit part 33 mounted thereon is formed integral with the housing 34 to produce a mobile apparatus.

An epoxy resin molding material may be filled in an area where the mold is removed to produce the mobile apparatus.

As set forth above, according to exemplary embodiments of the invention, a thin film has a conductive pattern and electronic devices thereon. This ensures a mobile apparatus to be manufactured with a smaller size and various external shapes.

While the present invention has been shown and described in connection with the exemplary embodiments, it will be apparent to those skilled in the art that modifications and variations can be made without departing from the spirit and scope of the invention as defined by the appended claims.

What is claimed is:

1. A mobile apparatus comprising:
a thin film provided as a substrate;
at least one conductive pattern formed on at least one surface of the thin film;
a circuit part formed on the at least one surface of the thin film to connect to the conductive pattern; and
a housing formed integral with the thin film.

2. The mobile apparatus of claim 1, wherein the thin film is a flexible film.

3. The mobile apparatus of claim 1, wherein the thin film is a polymer-based film.

4. The mobile apparatus of claim 1, wherein the at least one conductive pattern is an antenna pattern.

5. The mobile apparatus of claim 4, wherein the antenna pattern comprises two antenna patterns formed on both surfaces of the thin film, respectively.

6. The mobile apparatus of claim 5, wherein the antenna patterns have an identical shape and size to each other to form a balanced antenna, the antenna patterns being symmetrical with respect to each other.

7. The mobile apparatus of claim 1, wherein the housing is formed integral with the thin film by in-molding.

8. The mobile apparatus of claim 1, wherein the mobile apparatus is a mobile communication terminal.

9. A method of manufacturing a mobile apparatus, the method comprising:
forming at least one conductive pattern and at least one electrode connected to the conductive pattern to form a circuit on at least one surface of a thin film;
mounting at least one electronic device on the thin film to connect to the at least one electrode to form a circuit part;
inserting the thin film into a mold of a housing shape; and
injecting a molding material into the mold to form a housing to be integral with the thin film.

10. The method of claim 9, wherein the thin film is a flexible film.

11. The method of claim 9, wherein the thin film is a polymer-based film.

12. The method of claim 9, wherein the forming at least one conductive pattern and at least one electrode comprises printing a conductive ink.

13. The method of claim 9, wherein the forming at least one conductive pattern and at least one electrode comprises performing sputtering.

14. The method of claim 9, wherein the forming at least one conductive pattern and at least one electrode comprises bonding a metal foil.

15. The method of claim 9, wherein the forming at least one conductive pattern and at least one electrode comprises performing lithography.

16. The method of claim 9, wherein the at least one conductive pattern is an antenna pattern.

17. The method of claim 16, wherein the antenna pattern comprises two antenna patterns formed on both surfaces of the thin film, respectively.

18. The method of claim 17, wherein the antenna patterns have an identical shape and size to each other to form a balanced antenna, the antenna patterns being symmetrical with respect to each other.

19. The method of claim 9, wherein the mobile apparatus is a mobile communication terminal.
